(19) United States
(12) Patent Application Publication
(10) Pub. No.: US 2002/0021885 A1
(43) Pub. Date: Feb. 21, 2002

(54) Method for controlling frames of moving picture and apparatus therefor

(76) Inventors: Fusahiko Hasegawa, Kanagawa-ken (JP); Hajime Nose, Kanagawa-ken (JP); Kazuhiko Taniyama, Kanagawa-ken (JP)

Correspondence Address: BROWN RUDNICK FREED AND GESMER P C, BOX IP, 18TH FLOOR ONE FINANCIAL CENTER, BOSTON, MA, 02111, US

(21) Appl. No.: 09/902,885

(22) Filed: Jul. 11, 2001

(30) Foreign Application Priority Data
Aug. 21, 2000 (JP) 2000-250177
Sep. 5, 2000 (JP) 2000-268092

(51) Int. Cl. H04N 5/92; H04N 5/781

(52) U.S. Cl. 386/46; 386/125

(57) ABSTRACT

A method for controlling frames of a moving picture, includes: storing a first frame of the moving picture to a first buffer storing unit; transferring the first frame from the first buffer storing unit; storing a second frame of the moving picture to a second buffer storing unit; transferring the second frame from the second buffer storing unit; monitoring which is sooner in completely transferring of the first frame from the first buffer storing unit or in completely storing of the second frame to the second buffer storing unit; and deciding whether alternating or maintaining the transferring from and the storing to the first and second buffer storing units, based on a result of the monitoring step. Furthermore, an apparatus for controlling frames of a moving picture to achieve the method.

This patent application claims priority from Japanese patent application Nos. 2000-250177 filed on Aug. 21, 2000 and 2000-268092 filed on Sep. 5, 2000, the contents of which are incorporated herein by reference.

### BACKGROUND OF THE INVENTION

1. Field of the Invention

The present invention relates to a method for controlling frames of a moving picture and an apparatus therefor. In particular, the present invention relates to a method for controlling frames of a moving picture by use of multiple buffers, which copes with errors in transferring of frames, and an apparatus therefor.

2. Description of the Related Art

There is a moving picture controlling apparatus for recording data of a moving picture, which is provided from a picture-taking device such as a digital video camera, through an IEEE 1394 port without compressing the data according to a data compressing algorithm such as MPEG. According to recent development of magnetic recording media, such as a hard disc, the magnetic recording media has faster operating speed and larger storage capacity, so that it is expected to be a proper recording media for storing moving pictures.

However, in the conventional moving picture controlling apparatus, when errors such as a recording error or a reproducing error occur, a moving picture processing has difficulties. One of the difficulties is that, upon issuing the recording error, succeeding frames of a moving picture are delayed for processing. Another difficulty is that, upon issuing the reproducing error, nothing is shown on a monitor at least for a moment, i.e. black-out. These difficulties deteriorate a quality of the moving picture.

### SUMMARY OF THE INVENTION

Therefore, it is an object of the present invention to provide a method for controlling frames of a moving picture and an apparatus therefor, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, there is provided a method for controlling frames of a moving picture, comprising: storing a first frame of the moving picture to a first buffer storing unit; transferring the first frame from the first buffer storing unit; storing a second frame of the moving picture to a second buffer storing unit; transferring the second frame from the second buffer storing unit; monitoring completely transferring of the first frame from the first buffer storing unit and completely storing of the second frame to the second buffer storing unit to determine which is sooner; and deciding whether to alternate or maintain the transferring from and the storing to the first and second buffer storing units, based on a result of the monitoring step.

In the method, when complete storing of the second frame to the second buffer storing unit is sooner than complete transferring of the first frame from the first buffer storing unit in the monitoring step, the deciding step may further comprises storing a third frame of the moving picture in the second buffer storing unit.

In the method, when complete transferring of the first frame from the first buffer storing unit is sooner than complete storing of the second frame to the second buffer storing unit in the monitoring step, the deciding step may further comprises alternating the first and second buffer storing units such that the second frame is transferred from the second storing unit and a third frame of the moving picture is stored in the first buffer storing unit.

In the method, each of the steps of storing to the first buffer storing unit and of storing to the second buffer storing unit may include receiving frames from the moving picture in time sequence.

In the method, the deciding step may further comprise overwriting one or more succeeding frames following the second frame of the moving picture in the second buffer storing unit until the first frame is completely transferred from the first buffer storing unit.

In the method, the monitoring step may include monitoring whether a predetermined time passes in the transferring step of the first frame, and, when the predetermined time passes, the deciding step includes stopping the transferring of the first frame and starting the transferring of the second frame from the second buffer storing unit.

In the method, the monitoring step may include monitoring whether a predetermined time passes in the transferring step of the first frame, and, when the predetermined time passes, the deciding step includes stopping the storing of the succeeding frames to the second buffer storing unit.

In the method, each of the steps of transferring from the first buffer storing unit and transferring from the second buffer storing unit may include writing the stored frame to a hard disk.

In the method, in case where completely transferring of the first frame from the first buffer storing unit is sooner than completely storing of the second frame to the second buffer storing unit in the monitoring step, the deciding step may include transferring again the first frame from the first buffer storing unit.

In the method, if completely storing of the second frame to the second buffer storing unit is sooner than completely transferring of the first frame from the first buffer storing unit in the monitoring step, then the deciding step may include alternating the first and second buffer storing units such that the second frame is transferred from the second storing unit and a third frame of the moving picture is stored in the first buffer storing unit.

In the method, each of the steps of transferring from the first buffer storing unit and transferring from the second buffer storing unit may include transferring the frames to a display device.

In the method, in the deciding step, the first frame may be continuously transferred from the first storing unit to the display device until the second frame is completely stored to the second buffer storing unit.

In the method, the monitoring step may include monitoring whether a predetermined time passes in the storing step of the second frame, and wherein, when the predetermined time passes, the deciding step includes changing the second frame to a third frame to be stored.

In the method, each of the steps of storing to the first buffer storing unit and of storing to the second buffer storing unit may include reading out a frame from a hard disk.

According to the second aspect of the invention, there is provided an apparatus for controlling frames of a moving picture, comprising: a first buffer storing unit having a capacity of storing at least one frame; a second buffer storing unit having a capacity of storing at least one frame; a buffer storage processing unit which allocates, in time sequence, the frames of the moving picture in time sequence to the first buffer storing unit and the second buffer storing unit; and a buffer transferring unit which transfers a frame stored in either one of the first buffer storing unit and the second buffer storing unit, wherein, depending on which is sooner between completely transferring of one frame stored in either one of the first and second buffer storing units and completely storing of another frame succeeding the one frame to the other one of the first and second buffer storing units, the buffer storage processing unit and the buffer transferring unit alternate or maintain the transferring from and the storing to the first and second buffer storing units.

In the apparatus, the buffer transferring unit may include a completion signal generation unit which generates a completion signal to the buffer storage processing unit when the stored frame is completely transferred from the one of the first and second buffer storing units, and wherein the buffer storage processing unit includes a storage source changing unit which instructs to keep on storing one or more succeeding frames following the succeeding frame to the other of the first and second storing units until receiving the complete signal.

In the apparatus, the storage source changing unit may instruct to alternate the first and second storing units for storing a succeeding frame of the moving picture when the storage source changing unit receives the completion signal from the completion signal generation unit.

In the apparatus, when a predetermined time passes for transferring the stored frame from the one of the first and second buffer storing units, the buffer transferring unit may stop transferring the stored frame from the one of the first and second buffer storing frame and may start transferring the stored frame from the other of the first and second buffer storing units.

In the apparatus, when a predetermined time passes for transferring the stored frame from the one of the first and second buffer storing units, the buffer storage processing unit may stop storing the succeeding frames to the other of the first and second buffer storing units.

The apparatus may further comprises a hard disk in which the frames transferred from the frame transferring unit are written.

In the apparatus, the buffer storage processing unit may include a completion signal generation unit which generates a completion signal to the buffer storage processing unit when the frame is completely stored to the other of the first and second buffer storing units, and the buffer transferring unit may include a read-out source changing unit which instructs to transfer again the frame from the one of the first and second buffer storing units.

In the apparatus, the read-out source changing unit may instruct to alternate the first and second storing units for transferring the stored frame when the read-out source changing unit receives the complete signal from the completion signal generation unit.

The apparatus may further comprises a temporary stop instruction generation unit which generates a temporary stop signal upon a user's instruction, wherein the buffer transferring unit transfers again the frame from the one of the first and second buffer storing units when the buffer transferring unit receives the temporary stop signal from the temporary stop instruction generation unit.

In the apparatus, the buffer storage processing unit temporary may stop a frame to store to the other of the first and second storing units when the buffer storage processing unit receives the temporary stop signal from the temporary stop instruction generation unit.

In the apparatus, the buffer transferring unit may keep on transferring the frame from the one of the first and second buffer storing units until the instruction from the temporary stop instruction generation unit is released.

According to the third aspect of the invention, there is provided an apparatus for controlling frames of a moving picture, comprising: a first buffer storing unit has a capacity of storable at least one frame; a second buffer storing unit has a capacity of storable at least one frame; a buffer storage processing unit which allocates the frames in time sequence of the moving picture to the first buffer storing unit and the second buffer storing unit; a buffer transferring unit which transfers the frame stored in either one of the first buffer storing unit and the second buffer storing unit; and a temporary stop instruction generation unit which generates a temporary stop signal upon a user's instruction, wherein the buffer transferring unit transfers again the frame from the one of the first and second buffer storing units when the buffer transferring unit receives the temporary stop signal from the temporary stop instruction generation unit.

In the apparatus, the buffer storage processing unit may temporary stop a frame to store to the other of the first and second storing units when the buffer storage processing unit receives the temporary stop signal from the temporary stop instruction generation unit.

In the apparatus, the buffer transferring unit may keep on transferring the frame from the one of the first and second buffer storing units until releasing the instruction from the temporary stop instruction generation unit.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a functional block diagram of a moving picture recording apparatus of the first embodiment of the invention.

FIG. 2 shows a block diagram of the hard disk writing unit of the moving picture recording apparatus in more detail.

FIG. 3 shows a block diagram of the buffer storage processing unit of the moving picture recording apparatus more in detail.

FIG. 4 shows a flow chart of operations by the moving picture recording apparatus.

FIG. 5 shows a timing chart for the storage and the reading-out in the first embodiment.

FIG. 6 shows a block diagram of a moving picture recording apparatus according to the second embodiment of the invention.

FIG. 7 shows a block diagram of a moving picture reproducing apparatus according to the third embodiment of the present invention.

FIG. 8 shows a block diagram of the hard disc read-out processing unit more in detail.

FIG. 9 shows a block diagram of the buffer read-out processing unit more in detail.

FIG. 10 shows a flow chart of an operation of the moving picture reproducing device.

FIG. 11 shows a block diagram of a moving picture reproducing apparatus according to the fourth embodiment of the present invention.

FIG. 12 shows a block diagram of a moving picture reproducing device according to the fifth embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

An apparatus for controlling frames of a moving picture according to the first embodiment of the present invention is applied to a moving picture recording apparatus which stores image data of a captured moving picture into a hard disk. The moving picture recording apparatus of the first embodiment repeatedly stores, in case where a writing error occurs during writing the moving picture in the hard disk, image data of succeeding frames into the same buffer until the writing operation is completed. This prevents delay in importing the image data of the moving picture.

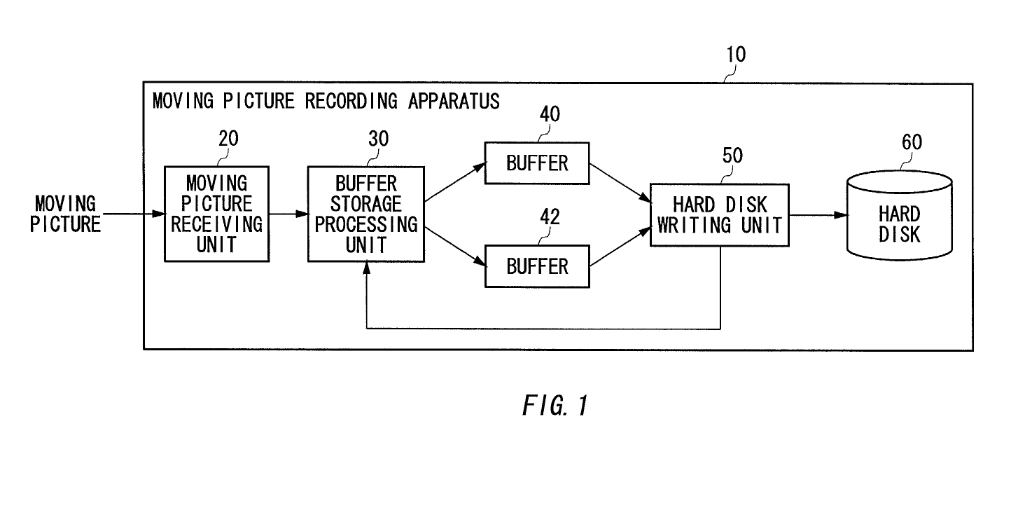

FIG. 1 shows a functional block diagram of the moving picture recording apparatus 10 of the first embodiment of the invention. The moving picture recording apparatus 10 has a moving picture receiving unit 20, a buffer storage processing unit 30, buffer storing units 40, 42, a hard disk writing unit 50 serving as a buffer transferring unit and a hard disk 60.

The moving picture receiving unit 20 receives a plurality of frames of a moving picture in time sequence. The moving picture receiving unit 20 serves as an interface for importing the image data of the moving picture into the moving picture recording apparatus 10. One example of the moving picture receiving unit 20 is an IEEE1394 port. Thus, the image data of the moving picture is imported with relatively high speed into the moving picture recording apparatus 10. The moving picture receiving unit 20 may connect with an image capturing equipment such as a digital video camera.

The hard disk 60 stores the plural frames in the moving picture. Since the data size of the moving picture is significantly large, it is preferred that the hard disk 60 has a significantly large data capacity. For example, the hard disc 60 may have a data storing capacity of dozens or hundreds of Giga Bytes (GB). Further, a substrate of the hard disc 60 may be made of aluminum, glass, etc.

Plural buffer storing units 40, 42 temporarily store respective frames which are to be written into the hard disk 60 before the respective frames are written into the hard disk 60. In the present embodiment, the buffer storing units 40, 42 include two (2) buffer memories. The buffer storing units 40, 42 may include semiconductor memories. Each of the buffer storing units 40, 42 has a capacity of storing at least one or more frames. Plural frames are stored, frame by frame i.e, search unit frame, into the buffer storing units 40, 42. The buffer storing units 40, 42 work for adjusting differences between speeds of importing the moving picture with the moving picture receiving unit 20 and of writing the moving picture in the hard disk 60. Furthermore, in this embodiment, the buffer storing units 40, 42 also serve to cope with an error in writing to the hard disk 60.

The buffer storage processing unit 30 receives the plural frames and allocates each of these frames to either one of the buffer storing units 40, 42. The plural frames which are received by the buffer storage processing unit 30 through the moving picture receiving unit 20 are ordered sequentially with a predetermined time interval. The buffer storage processing unit 30 distributes respective frames to respective buffer storing units 40, 42 with out delay in importing the plural frames. The buffer storage processing unit 30 switches the buffers to store the frames, according to a buffer changing condition described later in detail.

For instance, in case of a moving picture containing frames 1, 2, 3 and 4 in this order, the buffer storage processing unit 30 stores the frame 1 in the buffer storing unit 40, and then the buffer storage processing unit 30 stores the frame 2 in the buffer storing unit 42. Next, the buffer storage processing unit 30 overwrites the frame 3 on the buffer storing unit 40. Next, the buffer storage processing unit 30 overwrites the frame 4 on the buffer storing unit 42. Thus, the respective frames are alternately stored into the respective buffer storing units 40, 42 by overwriting. The processes described above make a normal buffer changing condition.

The hard disk writing unit 50 sequentially reads out the frames from the respective buffer storing units 40, 42 and transfers the same to write in the hard disk 60. For instance, in case where the frame 1 is stored in the buffer storing unit 40, the hard disk writing unit 50 reads out the frame 1 from the buffer storing unit 40 and writes the same in the hard disk 60. At this time, the buffer storage processing unit 30 stores the frame 2 fed from the moving picture receiving unit 20 in the buffer storing unit 42. After the writing of the frame 1 is completed, the hard disk writing unit 50 reads out the frame 2 from the buffer storing unit 42 and writes the same in the hard disk 60. At this time, the buffer storage processing unit 30 stores the frame 3 fed from the moving picture receiving unit 20 in the buffer storing unit 40. Thus, the respective frames 1, 2, 3 are sequentially read out from alternate one of the buffer storing units 40, 42, and written in the hard disk 60.

If the writing of the frame from one buffer storing unit in the hard disk 60 is not completed before the succeeding frame is stored into the other buffer storing unit, the buffer storage processing unit 30 repeatedly stores a next frame following the succeeding frame also into the other buffer storing unit. For example, if the writing of the frame 1 from the buffer storing unit 40 into the hard disk 60 is not yet completed before the succeeding frame 2 is stored into the buffer storing unit 42, the buffer storage processing unit 30 again stores the next succeeding frame 3 into the buffer storing unit 42. The buffer changing condition thus includes unchanging the buffer storing unit to store a succeeding frame. Accordingly, it may be prevented from delay in imposing frames in a moving picture.

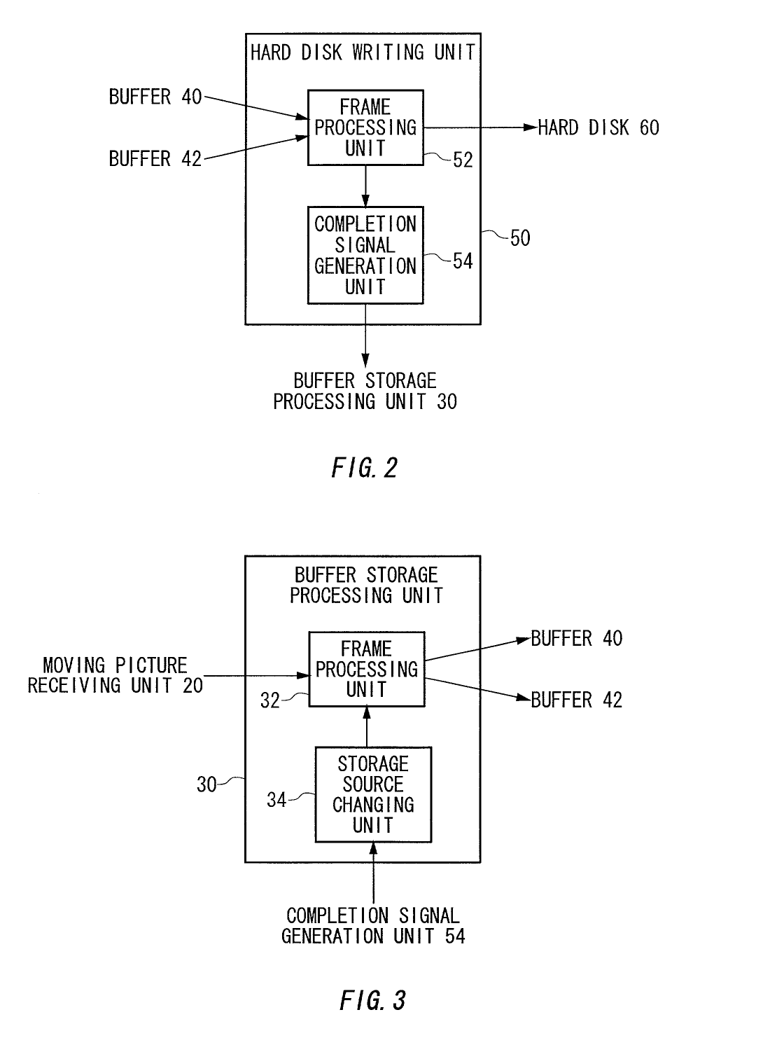

FIG. 2 shows a block diagram of the hard disk writing unit 50 of the moving picture recording apparatus 10 in more detail. The hard disk writing unit 50 has a frame processing unit 52 and a completion signal generation unit 54. The frame processing unit 52 operates reading-out and writing frames. The completion signal generation unit 54 sends out a completion signal when writing of each plural frames is completed.

The frame processing unit 52 changes a buffer now being read out to the other, if writing a frame in the hard disk 60 is not completed for a predetermined time period. For instance, in case where the time in writing the first frame read out from the buffer storing unit 40 exceeds the predetermined time period, the writing operation for the first frame is stopped and the next frame, i.e. the second frame is read out from the buffer storing unit 42 and written in the hard disk 60.

The frame processing unit 52 carries out the sequence process in which frames are sequentially written in the hard disk 60 when no error in writing occurs. Even if an error occurs in writing, the sequence process may be carried on, as described above. More specifically, in case of reading out frames 1, 2 and 3 in the order, even if an error occurs in writing the frame 1, the writing operation for the frame 1 is cancelled after the predetermined time period elapses, and then writing the frame 2 and succeeding frames may be started.

FIG. 3 shows a block diagram of the buffer storage processing unit 30 of the moving picture recording apparatus 10 in more detail. The buffer storage processing unit 30 has a frame processing unit 32 and a storage source changing unit 34. The frame processing unit 32 carries out the storing of frames. When the storage source changing unit 34 receives a completion signal from the completion signal generation unit 54 before the storing of a frame in one of the buffers is completed, the storage source changing unit 34 changes from the current storing buffer to the other buffer to store the succeeding frame. In other words, until the frame processing unit 32 receives the completion signal from the completion signal generation unit 54, the frame processing unit 32 continues to overwrite the frames sequentially in the same buffer.

More specifically, the storage source changing unit 34 receives the completion signal that represents the completion in writing the frame 1 in the hard disk 60 while the frame processing unit 32 is storing the frame 2 from the moving picture receiving unit 20 in the buffer storing unit 42. In this circumstance, after the storing of the frame 2 is completed, the storage source changing unit 34 changes the buffer storing unit 42 to the buffer storing unit 40 to receive the next frame, i.e. the frame 3.

The frame processing unit 32 thus starts storing the frame 3 to the buffer storing unit 40. If the storage source changing unit 34 does not receive the completion signal while the frame 3 is being stored in the buffer storing unit 40, the frame processing unit 32 keeps on storing the succeeding frames including the next frame 4 in the same buffer. As described above, the storage buffers for the frame are switched over depending on whether or not the completion signal is received.

When the writing time for a frame to the hard disk 60 exceeds the predetermined time period, the buffer storage processing unit 30 stops the repeated storage of the succeeding frames to the other buffer storing unit. More specifically, in case where the writing of the frame 1 from the buffer storing unit 40 to the hard disk 60 is not completed within the predetermined time period, the storage of the frame 2 and the succeeding frames thereof in the buffer storing unit 42 is stopped. Then, the latest frame stored in the buffer storing unit 42 starts being written in the hard disk 60, and the succeeding frame starts being stored in the buffer storing unit 40.

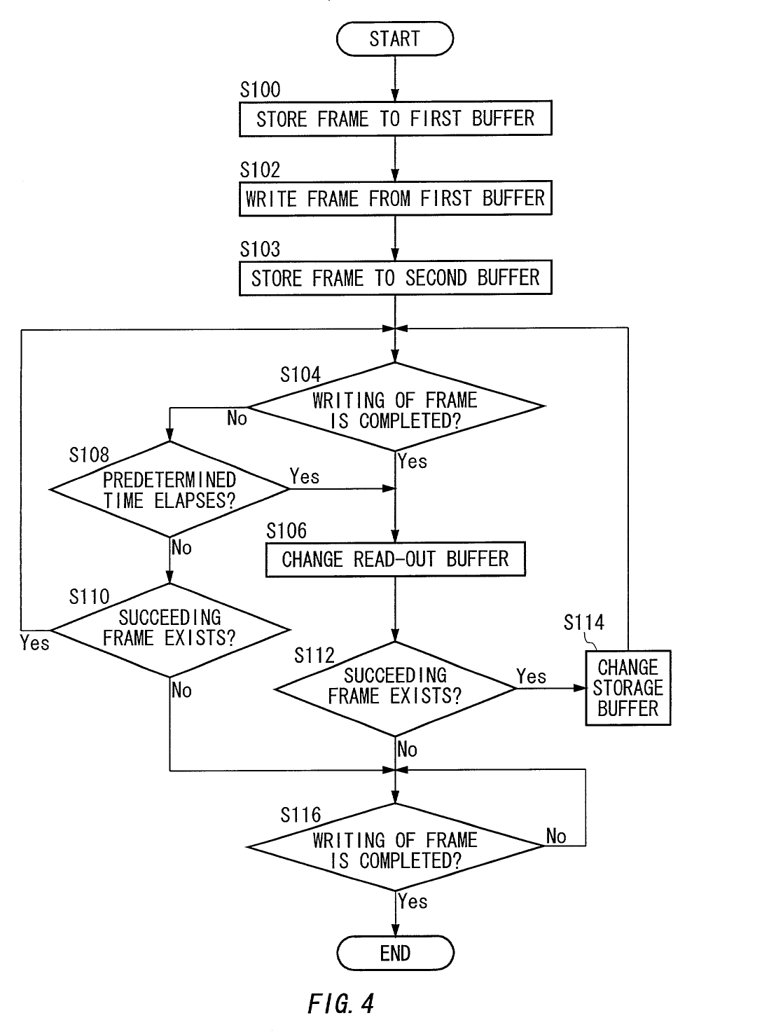

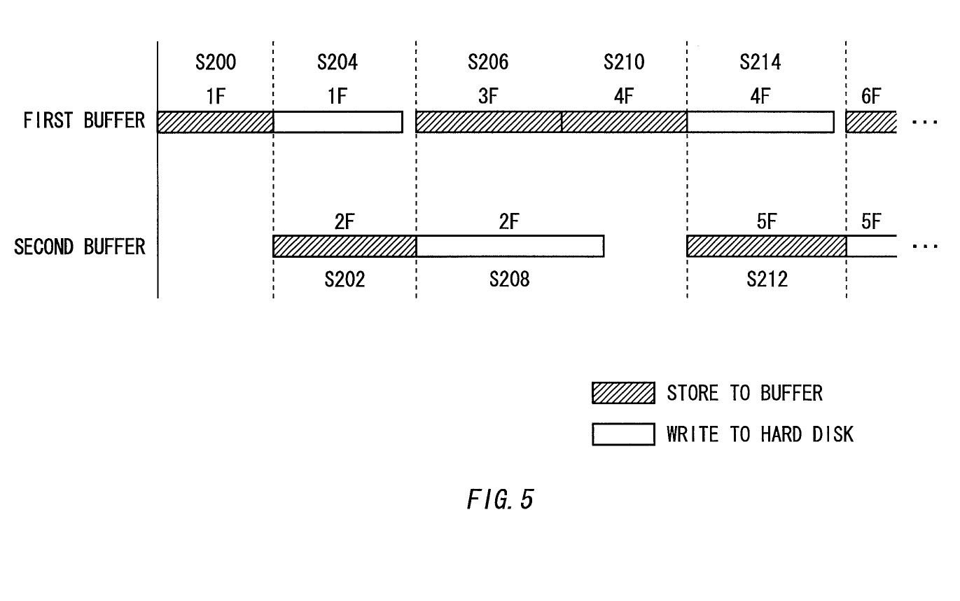

FIG. 4 shows a flow chart of operations carried out by the moving picture recording apparatus 10. At the beginning, the buffer storage processing unit 30 stores the first frame in the first buffer, for instance the buffer storing unit 40 (S100). Then, the hard disk writing unit 50 reads out the first frame from the first buffer, and starts writing the same to the hard disk 60 (S102) Furthermore, the buffer storage processing unit 30 starts storing the second frame in the second buffer, for instance the buffer storing unit 42 (S103).

Next, while the second frame is being stored in the second buffer, it is decided whether or not the writing of the first frame in the hard disk 60 is completed (S104). Namely, it is monitored which is sooner in completely transferring of the first frame from the buffer storing unit 40 to the hard disk 60 or in completely storing of the second frame into the buffer storing unit 42. If the writing is completed, the hard disk writing unit 50 changes the buffer from which the frame is read out to be written (S106). If the writing is not completed, it is decided whether or not the predetermined time period has elapsed (S108). When the writing time already exceeds the predetermined time period, the hard disk writing unit 50 changes the buffer from which the frame is read out to be written (S106). In case where the writing time does not yet exceed the predetermined time period and one or some succeeding frame exists, the succeeding frame(s) keep on being stored in the same buffer (S110). During this time, the present frame continues to be written. Otherwise, i.e. in case where no succeeding frame is present, the storage of the frame is stopped and the completion of the writing keeps on being monitored (S116). On the other hand, after the read-out buffer for writing is changed in the step S106, in case where there are one or more succeeding frames (S112), the storage buffer is changed for the succeeding frame(s) (S114). Then, the completion of the writing keeps on being monitored (S104). In case where no succeeding frame exists, the storage of the frame is stopped and the completion of the writing keeps on being monitored (S116). After the writing is finished, the recording of the moving picture is stopped in the moving picture recording apparatus 10.

As described above, if no error occurs, the steps S104, S106, S112, S114, S104 are repeated in the order, so that a lot of frames in a moving picture may sequentially be written in the hard disk 60. Furthermore, if an error occurs in writing, the steps S104, S108, S110, S104 are repeated in the order, so that the succeeding frames may be stored in the same buffer.

FIG. 5 shows a timing chart for the storage and the reading-out in the first embodiment. At first, the first frame is stored in the first buffer (S200). Then, the second frame is stored in the second buffer (S202). While the second frame is being stored in the second buffer, the first frame is readout from the first buffer and the same is written in the hard disk 60 (S204).

Next, the third frame is stored in the first buffer (S206). During the storage of the third frame in the first buffer, the second frame is read out from the second buffer and the same is written in the hard disk 60 (S208). In this event, if the writing of the second frame is not finished before the third frame is stored, the fourth frame is still stored in the first buffer (S210). If the writing of the second frame is finished before the fourth frame is stored, the fifth frame is sequentially stored in the second buffer (S212). During the storage of the fifth frame, the fourth frame is read out from the first buffer and the same is written in the hard disk 60 (S214).

According to the first embodiment of the invention, a plurality of buffers are alternately used, based on a buffer changing condition, so that the delay in importing a series of frames of a moving picture may be avoided.

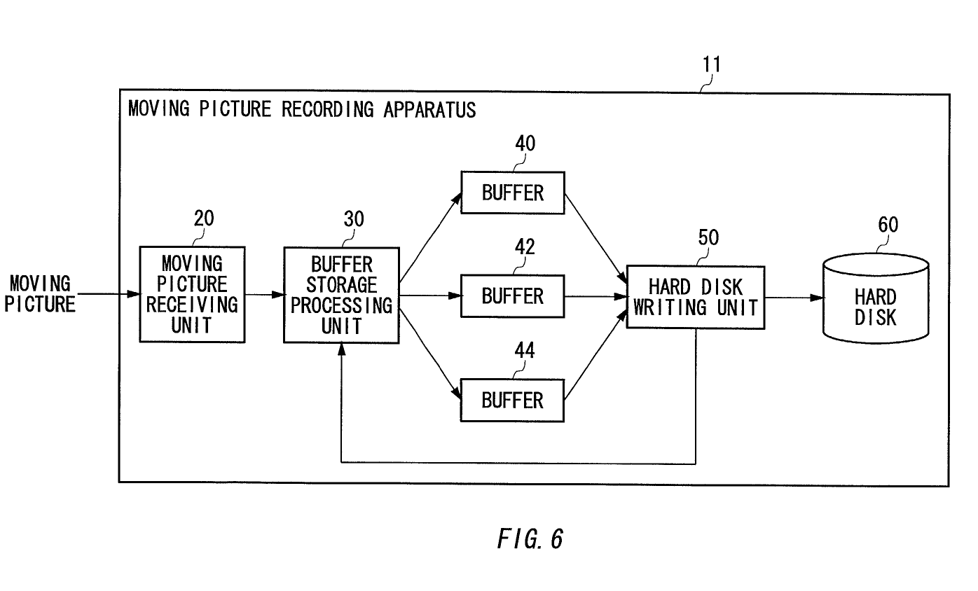

FIG. 6 shows a block diagram of a moving picture recording apparatus 11 according to the second embodiment of the invention. The moving picture recording apparatus 10 of the second embodiment includes three (3) buffer storing units 40, 42, 44, which is the difference from the first embodiment. The first to third buffers, i.e. the buffer storing units 40, 42, 44 are used in a predetermined order, so that the plural frames are stored therein and written in the hard disk 60.

According to these three (3) buffers, the number of overwriting on the buffers because of writing errors maybe reduced. For instance, in case where the writing from the buffer storing unit 40 to the hard disk 60 is not finished during the storage in the buffer storing unit 42, the succeeding frame is stored into the buffer storing unit 44. Consequently, it is not necessary to overwrite the frame stored in the buffer storing unit 42, so that the buffering effect may be further enhanced.

According to the first and second embodiments, even if errors in writing occur, the delay in importing the succeeding frames may be prevented.

Furthermore, according to the second embodiment, the number of overwriting on the buffers because of writing errors is reduced, so that the buffering effect may be further enhanced.

An apparatus for controlling frames of a moving picture according to the third embodiment of the present invention is applied to a moving picture recording apparatus which reproduces a moving picture stored in a hard disc and displays the reproduced moving picture on a display device, such as a monitor. According to the present embodiment, when a read-error happens while a moving picture is being read out from a hard disc, the moving picture reproducing apparatus of the present embodiment transfers a frame of the moving picture, which is read out just prior to the happening of the read-error to the display device. According to the present embodiment, it is possible to prevent the display device from displaying nothing when a read-error happens.

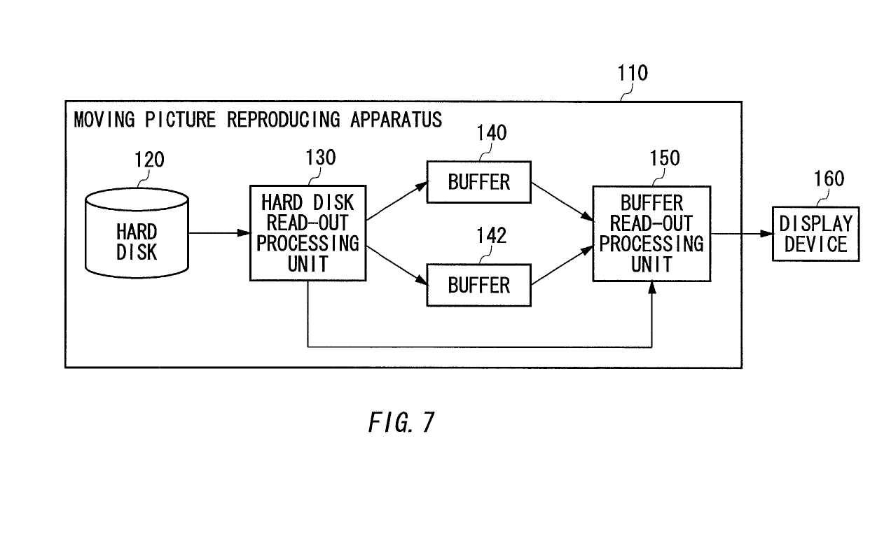

FIG. 7 shows a block diagram of the moving picture reproducing apparatus according to the third embodiment of the present invention. The moving picture reproducing device 110 has a hard disc 120, a disc read-out processing unit 130 serving as a buffer storage processing unit, a plurality of buffer storing units 140 and 142 and a buffer read-out processing unit 150 serving as a buffer transferring unit. The moving picture reproducing device 110 is coupled to a display device 160.

The hard disc 120 stores a plurality of frames included in a moving picture. Since the data size of a moving picture is relatively large, it is preferable for the hard disc 120 to have larger data storing capacity. For example, the hard disc 120 may have a data storing capacity of dozens or hundreds of Giga Bytes (GB). Further, a substrate of the hard disc 120 may be made of aluminum, glass, etc.

The buffer storing units 140 and 142 temporarily store a plurality of frames of a moving picture, the frames being read out from the hard disc 120, before the frames are transferred to the display device 160. According to the present embodiment, the buffer storing units 140 and 142 may be formed by using two (2) buffer memories. For example, the buffer storing units 140 and 142 may be formed by using semiconductor memories. Each of the buffer storing units 140 and 142 has enough storing capacity to store at least one frame of a moving picture. The buffer storing units 140 and 142 have a function of adjusting difference between a read-out rate of reading data of a moving picture from the hard disc 120 and a transfer rate of transferring data of the moving picture to the display device 60. Further, according to the present embodiment, the buffers to ring units 140 and 142 also have a function of coping with a read-error from the hard disc 20.

The disc read-out processing unit 130 sequentially reads out a plurality of frames of a moving picture from the hard disc 120, and distributes them to the respective buffer storing units 140 and 142. The plurality of frames readout by the disc read-out processing unit 130 are sequenced in time domain at a predetermined time period. The disc read-out processing unit 130 sequentially reads out a plurality of frames of a moving picture with a time period between the frames being maintained. The disc read-out processing unit 130 stores each of the frames into the plurality of buffer storing units 140 and 142 by unit frame.

For example, in case of a moving picture comprising frames 1, 2, 3 and 4 in this order, the disc read-out processing unit 130 stores the frame 1 into the buffer storing unit 140, and then the frame 2 into the buffer storing unit 142. Then, the disc read-out processing unit 130 stores the frame 3 into the buffer storing unit 140, and then, the disc read-out processing unit 130 stores the frame 4 into the buffer storing unit 142. By doing this, each of the plurality of buffer storing units 140 and 142 alternately stores each of plural frames.

The buffer read-out processing unit 150 sequentially reads out the frames of the moving picture from at least one of the buffer storing units 140 and 142 and transfers them to the display device 160. For example, when the frame 1 is stored in the buffer storing unit 140, the buffer read-out processing unit 150 reads out the frame 1 from the buffer storing unit 140 and transfers it to the display device 160. In the meantime, the disc read-out processing unit 130 reads out the frame 2 from the hard disc 120 and stores it into the buffer storing unit 142. After the read-out and transfer of the frame 1 of the moving picture are completed, the buffer read-out processing unit 150 reads out the frame 2 from the buffer storing unit 142 and transfers it to the display device 160. In the meantime, the disc read-out processing unit 130 reads out the frame 3 from the hard disc 120 and stores it into the buffer storing unit 140. By doing this, each of the frames 1, 2 and 3 of the moving picture is alternately read out from each of the buffer storing unit 140 and 142, and then transferred to the display device 160.

In case where a frame of the moving picture is not completely stored into one of the buffer storing unit 140 or 142 before a read-out operation of the disc read-out processing unit 130 starts, the buffer read-out processing unit 150 once again transfers a frame, which is already read out from the other one of the buffer storing unit 140 or 142, to the display device 60. For example, in case the frame 2 of the moving picture is not completely stored before the transfer of the frame 1 of the moving picture to the display device 160 is completed, the frame 1 of the moving picture is transferred to the display device 160 once again.

The display device 160 displays a plurality of frames which are consecutively transferred by the buffer read-out processing unit 150 as a reproduced moving picture.

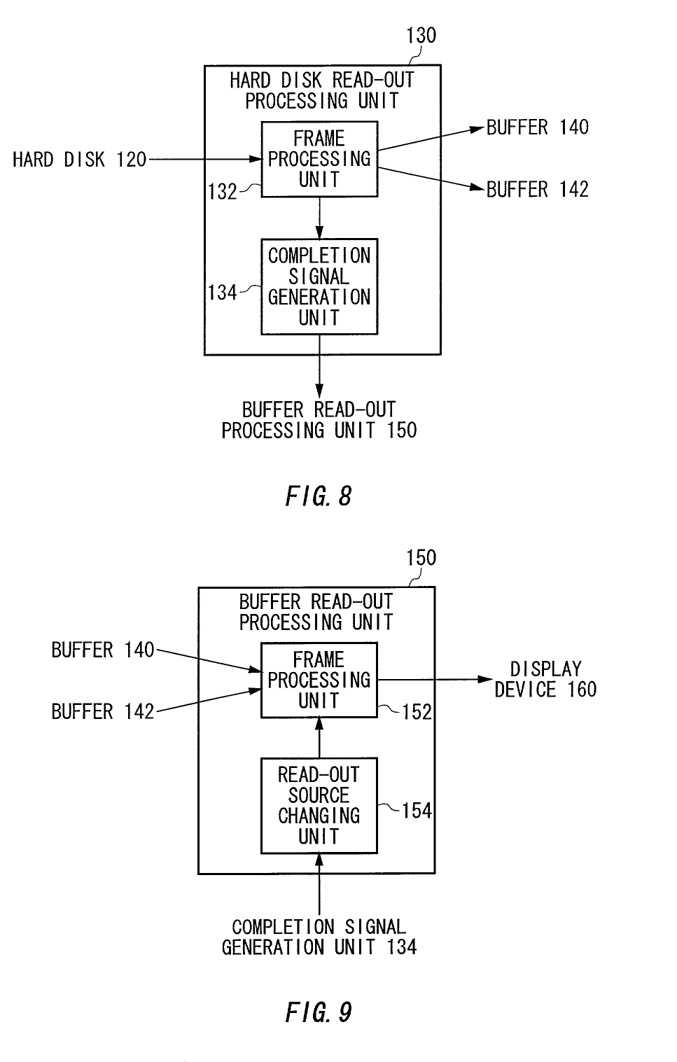

FIG. 8 shows a block diagram of the disc read-out processing unit 130 in more detail. The disc read-out processing unit 130 includes a frame processing unit 132 and a completion signal generating unit 134. The frame processing unit 132 performs a read-out and a write-in operations of frames of a moving picture. The completion signal generating unit 134 generates a completion signal when the frame processing unit 132 completes a read-out operation of frames of a moving picture from the hard disc 120. According to another example, the completion signal generating unit 134 generates a completion signal when the frame processing unit 132 completes both of a read-out and write-in operations of a frame of a moving picture.

In case where a frame is not completely read-out from the hard disc 120 after a predetermined time period, the frame processing unit 132 changes a frame to be read out with another one from that currently being read out. In other words, in case there is no error while a frame is being read out from the hard disc 120, the frame processing unit 132 performs a sequential operation for reading out frames in time sequence. Not only that, according to the embodiment, it is also possible to perform a sequential operation even though a read-error happens. For example, in case frames 1, 2 and 3 are sequentially read out, even though a read-error happens while frame 1 is being read out, it is possible to start reading out frame 2 by canceling reading of frame 1 after a predetermined time period has passed.

FIG. 9 shows a block diagram of the buffer read-out processing unit 150 in more detail. The buffer read-out processing unit 150 includes a frame processing unit 152 and a read-out source changing unit 154. The frame processing unit 152 performs a read-out and a transfer operations of a frame of a moving picture. The read-out source changing unit 154 changes one of the buffer storing units as a read-out source with the other one of the buffer storing units for the next frame from that currently being used as the read-out source if a completion signal is received before a frame is completely transferred to the display device 160. In other words, the frame processing unit 152 repeatedly reads out the same frame from the buffer storing unit 140 or 142 and repeatedly transfers it to the display device 160 until a completion signal is received from the completion signal generating unit 134.

For example, while the frame 1 is being read out from the buffer storing unit 140 and transferred to the display device 160, the read-out source changing unit 154 receives a completion signal which informs that the frame 2 is stored in the buffer storing unit 142. In this case, after the transfer of frame 1 to the display device 160, the read-out source changing unit 154 changes the buffer storing unit 140 with the buffer storing unit 142 as a read-out source from which the next frame is to be read out.

The frame processing unit 152 starts to read out the frame 2 from the buffer storing unit 142. If the read-out source changing unit 154 does not receive any read-out completion signal, the frame processing unit 152 keeps reading out the same frame from the same buffer storing unit and transferring it to the display device 60 during that time. As described above, a read-out source of a frame of a moving picture is changed according to whether or not the completion signal is received.

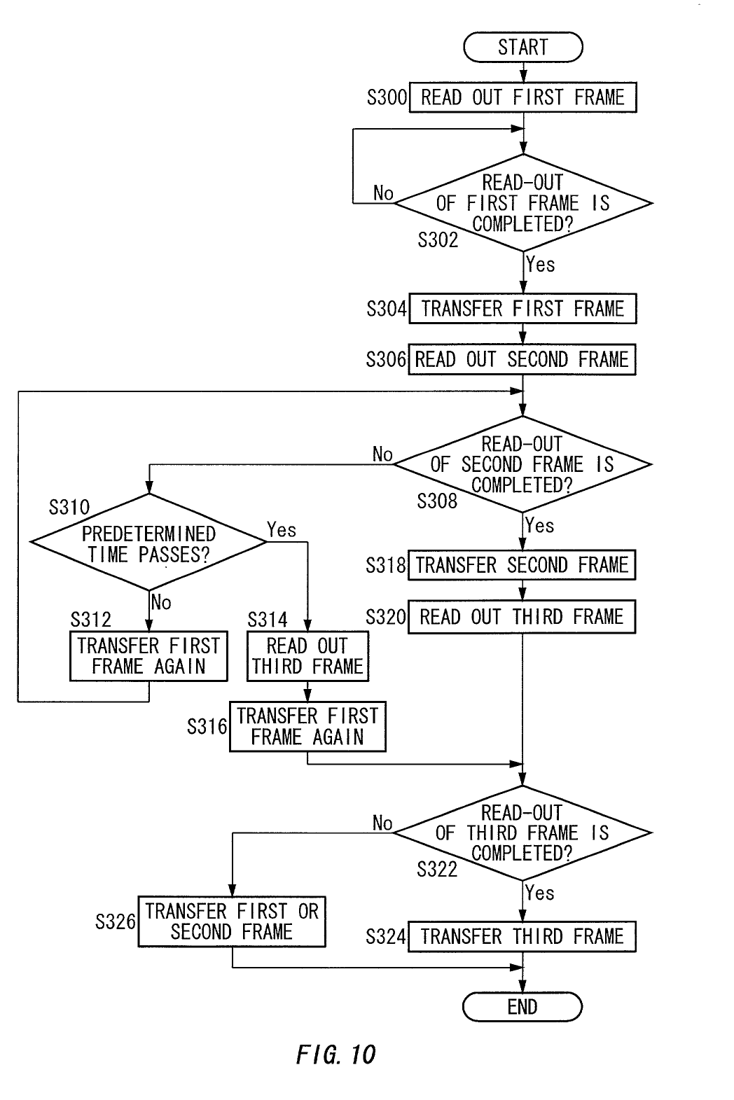

FIG. 10 shows a flow chart of an operation of the moving picture reproducing device 110. First, the disc read-out processing unit 130 starts to read out a first frame of a moving picture from the hard disc 120 and stores it into a first buffer, for instance buffer storing unit 140 (S300). Then, it is monitored whether or not the first frame of the moving picture is completely read out (S302). After the first frame is completely read out, the buffer read-out processing unit 150 starts to read out the first frame of the moving picture from the buffer storing unit 140 and transfer it to the display device 160 (S304).

Next, the disc read-out processing unit 130 starts to read out a second frame of the moving picture from the hard disc 120 and stores it into a second buffer, for instance buffer storing unit 142 (S306). Then, it is monitored whether or not the second frame is completely read out (S308). Namely, it is monitored which is sooner in completely transferring of the first frame from the buffer storing unit 140 to the display device 160 or in completely storing of the second frame into the buffer storing unit 142. If the second frame is completely read out before the first frame is completely transferred, the buffer read-out processing unit 150 starts to read out the second frame from the buffer storing unit 142 and transfer it to the display device 160 (S318). Then, a read-out operation of a third frame of the moving picture starts (S320).

On the other hand, if the second frame is not completely read out before the first frame is completely transferred, it is determined whether or not a predetermined time period has passed since the read-out operation of the second frame started (S310). If it is determined the predetermined time period has passed since the read-out operation of the second frame started, the disc read-out processing unit 130 stops reading out the second frame and starts to read out the third frame (S314). Then, the buffer read-out processing unit 150 starts to read out the first frame already transferred to the display device 160 from the first buffer and transfer it to the display device 160 once again (S316). If it is determined that the predetermined time period has not passed since the read-out operation of the second frame started, read out of the first frame already transferred to the display device 160 from the first buffer is stated and it is transferred to the display device 160 once again (S112). In this case, the disc read-out processing unit 130 keeps monitoring whether or not the second frame is read out and whether or not the second frame is completely read out (S308).

Next, if the read-out operation of the third frame is already started (S320 or S314), it is monitored whether or not the third frame is completely read out (S322). If the third frame is completely read out before the first or the second frame is completely transferred, the transfer of the third frame to the display device 160 is started (S324). If the third frame is not completely read out before the first or the second frame is completely transferred, read out of the first or the second frame already transferred to the display device 160 from the first or the second buffer is started and it is transferred to the display device 160 once again (S326).

By repeating the above-described operations, even though a read-error has happened for reading out a certain frame of a moving picture while a plurality of frames are transferred to the display device 160, it is possible to transfer other frame(s) of the moving picture to the display device 160. Therefore, it is possible to provide a quality moving picture without discontinuity during reproduction. According to the present embodiment, although the description is about read-out and transfer of frames 1, 2 and 3, the number of frames read out and transferred may be enormous according to the length of a moving picture being reproduced.

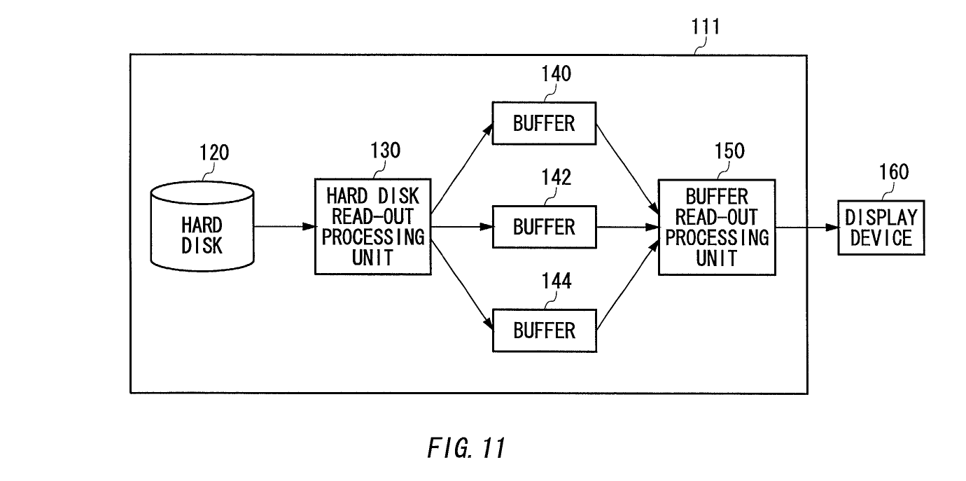

FIG. 11 shows a block diagram of a moving picture reproducing apparatus according to the fourth embodiment of the present invention. The moving picture reproducing apparatus 111 of the present embodiment includes three (3) buffers, which is the difference from the third embodiment. Other features and aspects are similar to those of the third embodiment. By using the first, second and third buffers (buffer storing units 140, 142 and 144) in a predetermined order, a plurality of frames are read out from the hard disc 120 and transferred to the display device 160.

For example, the present embodiment is especially preferable when the time required to read out a frame of a moving picture from the hard disc 120 and store it into a buffer is shorter than the time required to read out the frame from the buffer and transfer it to the display device. According to three (3) buffers, a frame may be stored into at least one of the two buffers while another frame is transferred from the remaining buffer. By doing this, buffering efficiency can be further increased.

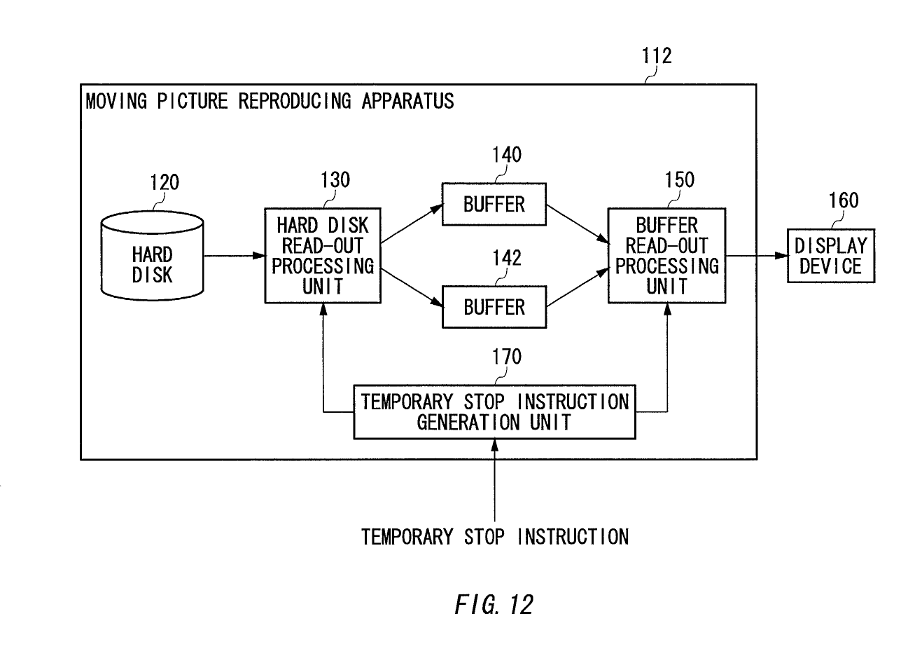

FIG. 12 shows a block diagram of a moving picture reproducing device according to the fifth embodiment of the present invention. The moving picture reproducing device 111 of the present embodiment has a function for temporary stopping reproduction of a moving picture and includes a temporary stop instruction generating unit 170, which is the difference from the third embodiment. Other features and aspects are similar to those of the third embodiment.

The temporary stop instruction generating unit 170 stops transferring a frame of a moving picture to the display device 160 based on control of a user. The temporary stop instruction generating unit 170 provides, upon the user's instruction, a temporary stop signal, which instructs to stop transfer of a frame of a moving picture to the disc read-out processing unit 130 and the buffer read-out processing unit 150.

The disc read-out processing unit 130 stops operations of reading out a frame from the hard disc 120 and storing it into the buffer storing units 140 and 142 when the temporary stop signal is received from the temporary stop instruction generating unit 170. Further, in case where the temporary stop signal is received while the operation of reading out a certain frame or storing the same is being performed, it is also possible to instruct to stop the operation of reading out or storing after waiting for completion of the operation of reading out the frame or storing the same.

The buffer read-out processing unit 150 reads out the frame already read out from the buffer storing unit 140 or 142 and transfers it to the display device 60 when the temporary stop signal is received from the temporary stop instruction generating unit 170. For example, in case where the temporary stop signal is received while the operation is being performed, even though the frame is completely transferred, the same frame is repeatedly transferred. In this case, the buffer read-out processing unit 150 repeatedly reads out the same frame from the buffer storing unit 140 or 142 and transfers it to the display device 160 until the instruction is released from the temporary stop instruction generation unit by invalidating the temporary stop signal by the user.

For example, the temporary stop instruction generating unit 170 may be a temporary stop button which can be pushed by the user. In this case, the temporary stop signal maybe invalidated by pushing the temporary stop button again. Of course, it is still possible to include a separate button for instructing invalidation of the temporary stop signal.

According to the present embodiment, even though reproduction of a moving picture is temporarily stopped, the frame being reproduced at the moment of the temporary stop of the reproduction can be continuously displayed on the display device, which makes a user feel better than the conventional case where nothing is displayed on the display device under the same situation.

As described above, according to the moving picture reproducing apparatus of the above described embodiments, a plurality of frames of the moving picture are transferred to the display device 160, and a frame of a moving picture may be further transferred to the display device 160 even when a read-error happens while another frame of the moving picture is being read out from the hard disc 120. Therefore, it is possible to remove any discontinuity of a moving picture being reproduced on the display device, so that quality of reproduced moving picture can be enhanced.

Further, the fourth embodiment is especially preferable when the time required to read out a frame of a moving picture from the hard disc 120 and store it into a buffer is shorter than the time required to read out the frame from the buffer and transfer it to the display device. In this embodiment, since three (3) buffers are used, it is possible to store a frame into at least one of the two buffers while another frame is transferred from the remaining buffer. By doing this, buffering efficiency can be increased.

According to the fifth embodiment, even though reproduction of a moving picture is temporarily stopped, the frame being reproduced at the moment of the temporary stop of the reproduction can be continuously displayed on the display device, which makes a user feel better than the conventional case where nothing is displayed on the display device under the same situation.

Although the present invention has been described by way of exemplary embodiments, it should be understood that those skilled in the art might make many changes and substitutions without departing from the spirit and the scope of the present invention which is defined only by the appended claims.

According to one of the possible examples of the modifications, an apparatus for controlling frames of a moving picture may include more than four (4) buffers. Further, it is also possible to include one buffer of a relatively large storing capacity so that the storing capacity of a plurality of buffers can be distributed over one buffer.

According to another example of the modifications, an apparatus for controlling frames of a moving picture may include a plurality of hard discs. In this case, the plurality of hard discs may be considered as a virtual one hard disc.

According to yet another example of the modifications, an apparatus for controlling frames of a moving picture may combine a recording function and a reproducing function on the hard disc.

According to another example of the modifications, the hard disc and the disc read-out processing unit may be a single-bodied hard disc device which can be removably installed on an apparatus for controlling a moving picture.

As described above, according to a method and an apparatus for controlling frames of a moving picture of the present invention, it is possible to provide a quality-enhanced process of a moving picture.

What is claimed is:

1. A method for controlling frames of a moving picture, comprising:
storing a first frame of the moving picture to a first buffer storing unit;
transferring the first frame from the first buffer storing unit;
storing a second frame of the moving picture to a second buffer storing unit;
transferring the second frame from the second buffer storing unit;
monitoring completely transferring of the first frame from the first buffer storing unit and completely storing of the second frame to the second buffer storing unit to determine which is sooner; and
deciding whether to alternate or maintain the transferring from and the storing to the first and second buffer storing units, based on a result of the monitoring step.

2. The method as claimed in claim 1, wherein when complete storing of the second frame to the second buffer storing unit is sooner than complete transferring of the first frame from the first buffer storing unit in the monitoring step, the deciding step further comprises storing a third frame of the moving picture in the second buffer storing unit.

3. The method as claimed in claim 2, wherein when complete transferring of the first frame from the first buffer storing unit is sooner than complete storing of the second frame to the second buffer storing unit in the monitoring step, the deciding step further comprises alternating the first and second buffer storing units such that the second frame is transferred from the second storing unit and a third frame of the moving picture is stored in the first buffer storing unit.

4. The method as claimed in claim 2, wherein each of the steps of storing to the first buffer storing unit and of storing to the second buffer storing unit includes receiving frames from the moving picture in time sequence.

5. The method as claimed in claim 4, wherein the deciding step further comprises overwriting one or more succeeding frames following the second frame of the moving picture in the second buffer storing unit until the first frame is completely transferred from the first buffer storing unit.

6. The method as claimed in claim 4, wherein the monitoring step includes monitoring whether a predetermined time passes in the transferring step of the first frame, and wherein, when the predetermined time passes, the deciding step includes stopping the transferring of the first frame and starting the transferring of the second frame from the second buffer storing unit.

7. The method as claimed in claim 4, wherein the monitoring step includes monitoring whether a predetermined time passes in the transferring step of the first frame, and wherein, when the predetermined time passes, the deciding step includes stopping the storing of the succeeding frames to the second buffer storing unit.

8. The method as claimed in claim 4, wherein each of the steps of transferring from the first buffer storing unit and transferring from the second buffer storing unit includes writing the stored frame to a hard disk.

9. The method as claimed in claim 1, wherein in case where completely transferring of the first frame from the first buffer storing unit is sooner than completely storing of the second frame to the second buffer storing unit in the monitoring step, the deciding step includes transferring again the first frame from the first buffer storing unit.

10. The method as claimed in claim 9, wherein if completely storing of the second frame to the second buffer storing unit is sooner than completely transferring of the first frame from the first buffer storing unit in the monitoring step, then the deciding step includes alternating the first and second buffer storing units such that the second frame is transferred from the second storing unit and a third frame of the moving picture is stored in the first buffer storing unit.

11. The method as claimed in claim 9, wherein each of the steps of transferring from the first buffer storing unit and transferring from the second buffer storing unit includes transferring the frames to a display device.

12. The method as claimed in claim 11, wherein in the deciding step, the first frame is continuously transferred from the first storing unit to the display device until the second frame is completely stored to the second buffer storing unit.

13. The method as claimed in claim 11, wherein the monitoring step includes monitoring whether a predetermined time passes in the storing step of the second frame, and wherein, when the predetermined time passes, the deciding step includes changing the second frame to a third frame to be stored.

14. The method as claimed in claim 9, wherein each of the steps of storing to the first buffer storing unit and of storing to the second buffer storing unit includes reading out a frame from a hard disk.

15. An apparatus for controlling frames of a moving picture, comprising:
a first buffer storing unit having a capacity of storing at least one frame;
a second buffer storing unit having a capacity of storing at least one frame;
a buffer storage processing unit which allocates, in time sequence, the frames of the moving picture in time sequence to the first buffer storing unit and the second buffer storing unit; and
a buffer transferring unit which transfers a frame stored in either one of the first buffer storing unit and the second buffer storing unit,
wherein, depending on which is sooner between completely transferring of one frame stored in either one of the first and second buffer storing units and completely storing of another frame succeeding the one frame to the other one of the first and second buffer storing units, the buffer storage processing unit and the buffer transferring unit alternate or maintain the transferring from and the storing to the first and second buffer storing units.

16. The apparatus as claimed in claim 15, wherein the buffer transferring unit includes a completion signal generation unit which generates a completion signal to the buffer storage processing unit when the stored frame is completely transferred from the one of the first and second buffer storing units, and wherein the buffer storage processing unit includes a storage source changing unit which instructs to keep on storing one or more succeeding frames following the succeeding frame to the other of the first and second storing units until receiving the complete signal.

17. The apparatus as claimed in claim 16, wherein the storage source changing unit instructs to alternate the first and second storing units for storing a succeeding frame of the moving picture when the storage source changing unit receives the completion signal from the completion signal generation unit.

18. The apparatus as claimed in claim 16, wherein when a predetermined time passes for transferring the stored frame from the one of the first and second buffer storing units, the buffer transferring unit stops transferring the stored frame from the one of the first and second buffer storing frame and starts transferring the stored frame from the other of the first and second buffer storing units.

19. The apparatus as claimed in claim 16, wherein when a predetermined time passes for transferring the stored frame from the one of the first and second buffer storing units, the buffer storage processing unit stops storing the succeeding frames to the other of the first and second buffer storing units.

20. The apparatus as claimed in claim 16, further comprising a hard disk in which the frames transferred from the frame transferring unit are written.

21. The apparatus as claimed in claim 15, wherein the buffer storage processing unit includes a completion signal generation unit which generates a completion signal to the buffer storage processing unit when the frame is completely stored to the other of the first and second buffer storing units, and wherein the buffer transferring unit includes a read-out source changing unit which instructs to transfer again the frame from the one of the first and second buffer storing units.

22. The apparatus as claimed in claim 21, wherein the read-out source changing unit instructs to alternate the first and second storing units for transferring the stored frame when the read-out source changing unit receives the complete signal from the completion signal generation unit.

23. The apparatus as claimed in claim 15, further comprising a temporary stop instruction generation unit which generates a temporary stop signal upon a user's instruction, wherein the buffer transferring unit transfers again the frame from the one of the first and second buffer storing units when the buffer transferring unit receives the temporary stop signal from the temporary stop instruction generation unit.

24. The apparatus as claimed in claim 23, wherein the buffer storage processing unit temporary stops a frame to store to the other of the first and second storing units when the buffer storage processing unit receives the temporary stop signal from the temporary stop instruction generation unit.

25. The apparatus as claimed in claim 23, wherein the buffer transferring unit keeps on transferring the frame from the one of the first and second buffer storing units until the instruction from the temporary stop instruction generation unit is released.

26. An apparatus for controlling frames of a moving picture, comprising:
a first buffer storing unit has a capacity of storable at least one frame;
a second buffer storing unit has a capacity of storable at least one frame;
a buffer storage processing unit which allocates the frames in time sequence of the moving picture to the first buffer storing unit and the second buffer storing unit;
a buffer transferring unit which transfers the frame stored in either one of the first buffer storing unit and the second buffer storing unit; and
a temporary stop instruction generation unit which generates a temporary stop signal upon a user's instruction, wherein the buffer transferring unit transfers again the frame from the one of the first and second buffer storing units when the buffer transferring unit receives the temporary stop signal from the temporary stop instruction generation unit.

27. The apparatus as claimed in claim 26, wherein the buffer storage processing unit temporary stops a frame to store to the other of the first and second storing units when the buffer storage processing unit receives the temporary stop signal from the temporary stop instruction generation unit.

28. The apparatus as claimed in claim 26, wherein the buffer transferring unit keeps on transferring the frame from the one of the first and second buffer storing units until releasing the instruction from the temporary stop instruction generation unit.
